(19) United States
(12) Patent Application Publication
(10) Pub. No.: US 2018/0027244 A1
(43) Pub. Date: Jan. 25, 2018

(54) VIDEO ENCODING APPARATUS WITH VIDEO ENCODER ADAPTIVELY CONTROLLED ACCORDING TO AT LEAST TRANSMISSION STATUS OF COMMUNICATION LINK AND ASSOCIATED VIDEO ENCODING METHOD

(71) Applicant: MEDIATEK INC., Hsin-Chu (TW)

(72) Inventors: Lien-Fei Chen, Taoyuan City (TW); Tung-Hsing Wu, Chiayi City (TW); Li-Heng Chen, Tainan City (TW); Han-Liang Chou, Hsinchu County (TW)

(21) Appl. No.: 15/654,706

(22) Filed: Jul. 20, 2017

Related U.S. Application Data
(60) Provisional application No. 62/364,909, filed on Jul. 21, 2016.

(51) Int. Cl. H04N 19/172; H04N 19/149; H04N 19/174; H04N 19/124; H04N 19/159

(52) U.S. Cl. CPC H04N 19/172; H04N 19/124; H04N 19/159; H04N 19/174; H04N 19/149

(57) ABSTRACT

An exemplary video encoding apparatus has a video encoder, a transmitter, and a control circuit. The video encoder encodes a video sequence into a compressed video bitstream. The transmitter transmits the compressed video bitstream via a communication link. The control circuit adaptively adjusts an encoding behavior of the video encoder according to at least a transmission status of the communication link.

### CROSS REFERENCE TO RELATED APPLICATIONS

This application claims the benefit of U.S. provisional application No. 62/364,909, filed on Jul. 21, 2016 and incorporated herein by reference.

### BACKGROUND

The present invention relates to encoding a video sequence, and more particularly, to a video encoding apparatus with a video encoder adaptively controlled according to at least a transmission status of a communication link and an associated video encoding method.

In general, WiFi (Wireless Fidelity) networks support certain maximum connection speeds (data rates) depending on their configurations. However, the maximum speed can automatically change over time. This behavior is called dynamic rate scaling, a design feature of the Wi-Fi network. Its speed is calculated according to the current signal quality of the connection to maintain a reliable communication link between wireless devices. This extends the range at which wireless devices can connect to each other in return for lower network performance at the longer distance or interference condition. However, due to the wireless network bandwidth variation over time, it is possible that a large-sized data chunk of a first wireless device cannot be fully transmitted to a second wireless device in time under a low wireless network bandwidth. When the first wireless device is a video source and the second wireless device is a video playback device, the video playback quality is degraded under this condition.

### SUMMARY

One of the objectives of the claimed invention is to provide a video encoding apparatus with a video encoder adaptively controlled according to at least a transmission status of a communication link and an associated video encoding method.

According to a first aspect of the present invention, an exemplary video encoding apparatus is disclosed. The exemplary video encoding apparatus includes a video encoder, a transmitter and a control circuit. The video encoder is arranged to encode a video sequence into a compressed video bitstream. The transmitter is arranged to transmit the compressed video bitstream via a communication link. The control circuit is arranged to adaptively adjust an encoding behavior of the video encoder according to at least a transmission status of the communication link.

According to a second aspect of the present invention, an exemplary video encoding method is disclosed. The exemplary video encoding method includes: adaptively adjusting an encoding behavior of a video encoding operation according to at least a transmission status of a communication link; performing the video encoding operation to encode a video sequence into a compressed video bitstream; and transmitting the compressed video bitstream via the communication link.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first video encoding apparatus according to an embodiment of the present invention.

FIG. 2 is a diagram illustrating a second video encoding apparatus according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

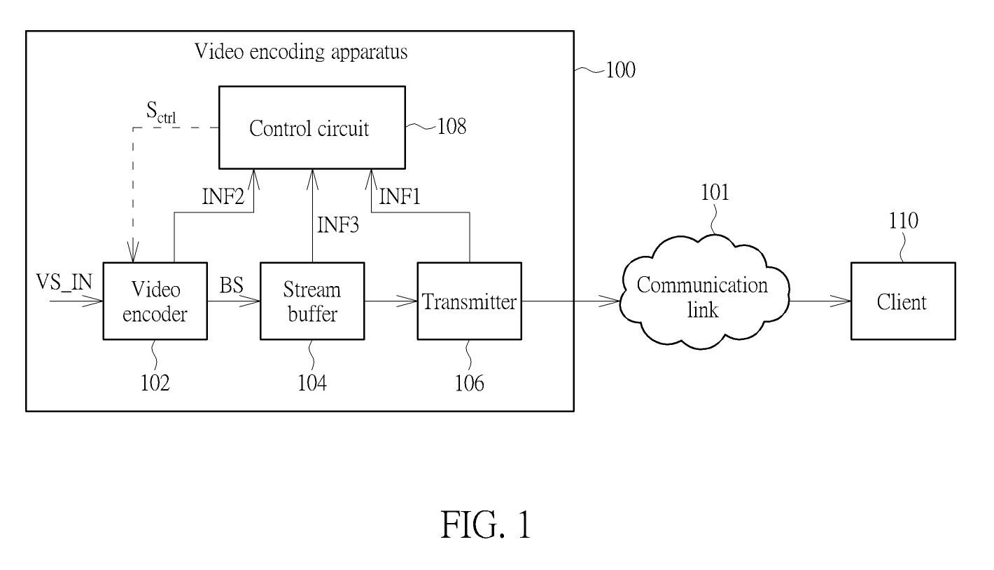

FIG. 1 is a diagram illustrating a first video encoding apparatus according to an embodiment of the present invention. The video encoding apparatus 100 includes a video encoder 102, a stream buffer 104, a transmitter 106, and a control circuit 108. For example, the video encoding apparatus 100 may be a part of an electronic device that is required to provide compressed video data (i.e., encoded video data) to a client 110 via a communication link 101. In one exemplary design, the communication link 101 may be a wireless link supporting a variable bandwidth, such as a WiFi network with dynamic rate scaling. In another exemplary design, the communication link 101 may be a wired link supporting a variable bandwidth. In short, the present invention has no limitation on the type of the communication link 101. Any electronic device using the proposed video encoder control scheme falls within the scope of the present invention.

In FIG. 1, the data path is represented by a solid line, while the control path is represented by a broken line. For example, one control signal can be delivered via a control path between the control circuit 108 and the video encoder 102, one data signal can be delivered via a data path between the control circuit 108 and the video encoder 102, one data signal can be delivered via a data path between the control circuit 108 and the stream buffer 104, and one data signal can be delivered via a data path between the control circuit 108 and the transmitter 106.

The video encoder 102 is used to perform a video encoding operation for encoding a video sequence VS_IN into a compressed video bitstream BS. For example, the video sequence VS_IN may be provided from an image capture device such as a digital camera. The video encoder 102 may employ any coding standard to implement the video encoding operation. The employed coding standard may adopt a block based coding technique to exploit spatial and temporal redundancy. For example, one basic approach is to divide a video frame into a plurality of blocks, perform intra prediction/inter prediction on each block, transform residues of each block, and perform quantization, scan and entropy encoding. Besides, a reconstructed frame is generated in a coding loop to provide reference pixel data used for coding following blocks. For certain video coding standards, in-loop filter(s) may be used for enhancing the image quality of the reconstructed frame. Since the present invention does not focus on the internal architecture of the video encoder 102, further description is omitted here for brevity.

The stream buffer 104 is coupled between the video encoder 102 and the transmitter 106. Hence, the stream buffer 104 is used to receive data of the compressed video bitstream BS generated from the video encoder 102, and provides buffered data of the compressed video bitstream BS to the transmitter 106 for data transmission. The stream buffer 104 may be implemented using an internal storage device, an external storage device, or a combination of an internal storage device and an external storage device. For example, the internal storage device may be a static random access memory (SRAM) or may be flip-flops; and the external storage device may be a dynamic random access memory (DRAM) or may be a flash memory. However, these are for illustrative purposes only, and are not meant to be limitations of the present invention.

The transmitter 106 is used to transmit the compressed video bitstream BS (particularly, buffered data of the compressed video bitstream BS read from the stream buffer 105) via the communication link 101. For example, the transmitter 106 packs data of the compressed video bitstream BS into packets, and transmits the packets via the communication link 101. In a case where the communication link 101 is a wireless link, the transmitter 106 is implemented using a wireless transmitter. In another case where the communication link 101 is a wired link, the transmitter 106 is implemented using a wired transmitter.

In this embodiment, the communication link 101 supports a variable bandwidth (e.g., WiFi dynamic rate scaling). The present invention proposes using the control circuit 108 to adaptively adjust an encoding behavior of the video encoder 102 to solve a video playback quality degradation issue caused by the variable bandwidth of the communication link 101. For example, the video encoder 102 is adaptively adjusted to generate encoded video data in a variable bitrate in response to the bandwidth variation of the communication link 101.

The transmitter 106 of the video encoding apparatus 100 is configured to adopt a connection speed (data rate) of the communication link 106 within each time slot for data transmission. In other words, the transmitter 106 may have different settings at different time stamps to transmit compressed video data (i.e., encoded video data) under different connection speeds (data rates) within different time slots, respectively. Hence, the transmitter 106 has information of the transmission status of the communication link 106 (e.g., link capacity/bandwidth of the communication link 106). The control circuit 108 may obtain the transmission status of the stream buffer 104 by actively requesting the transmitter 106 to get the information INF1 or by passively informed of the information INF1 provided from the transmitter 106, where the information INF1 is indicative of the transmission status of the communication link 106.

The control circuit 108 may further obtain an encoding status of the video encoder 102 (e.g., a size of a portion of the compressed video bitstream BS generated from the video encoder 102 to the stream buffer 104) by actively monitoring the video encoding operation performed by the video encoder 102 to get the information INF2 or by passively informed of the information INF2 provided from the video encoder 102, where the information INF2 is indicative of the encoding status of the video encoder 102 (e.g., the size of a portion of the compressed video bitstream BS generated by the video encoder 102). In this embodiment, the video sequence VS_IN may include a plurality of video frames, each video frame may include a plurality of coding units (CUs), and each CU may include a plurality of pixels. The aforementioned portion of the compressed video bitstream BS may be a compressed bitstream of a complete video frame of the video sequence VS_IN or a compressed bitstream of a partial video frame (e.g., a slice in one video frame or some CUs in one video frame) of the video sequence VS_IN. It should be noted that the information INF2 may be optional, depending upon the actual design considerations.

The control circuit 108 may further obtain a buffer status of the stream buffer 104 (e.g., a size of encoded video data that are kept in the stream buffer 104 and are still waiting for being transmitted via the communication link 101) by actively monitoring data access of the stream buffer 104 to get the information INF3 or by passively informed of the information INF3 provided from the stream buffer 104, where the information INF3 is indicative of the buffer status of the stream buffer 104. It should be noted that the information INF3 may be optional, depending upon the actual design considerations.

In one exemplary design, the control circuit 108 may adaptively adjust the encoding behavior of the video encoder 102 according to the transmission status of the communication link 106 (which is indicated by the information INF1 actively/passively obtained from the transmission setting of the transmitter 106). For example, the control circuit 108 controls the encoding behavior of the video encoder 102 by setting at least one encoding parameter of the video encoder 102, wherein the video sequence VS_IN includes a plurality of video frames to be encoded by the video encoder 102, and the at least one encoding parameter of the video encoder 102 includes a target maximum compressed bitstream size (i.e., a target bit budget) of the video sequence VS_IN that is not encoded by the video encoder 102 yet. The control circuit 108 may act as a bitrate management unit for applying real-time adaptive bitrate management/adjustment to the video encoder 102.

Hence, before the video encoding operation is applied to the video sequence VS_IN (which includes more than one video frame), the information INF1 obtained by the control circuit 108 at a time stamp t₀ may indicate that the transmitter 106 is configured to have a link capacity (e.g., network bandwidth) X₀ within a time slot TS_{t0,t1} from the current time stamp t₀ to a next time stamp t₁. At the time tamp t₀, the control circuit 108 refers to the link capacity (e.g., network bandwidth) X₀ within the time slot TS_{t0,t1} to estimate a target maximum compressed bitstream size cuBSr₀ of the video sequence VS_IN (i.e., a target bit budget allocated to the compressed video bitstream BS generated from encoding the video sequence VS_IN), and transmits the target maximum compressed bitstream size cuBSr₀ to the video encoder 102 via the control signal S_{ctrl}. After notified by the control signal S_{ctrl}, a rate controller (not shown) in the video encoder 102 may refer to the target maximum compressed bitstream size cuBSr₀ decided by the control circuit 108 to adaptively adjust a quantization parameter (QP) of each coding unit included in the video frames of the video sequence VS_IN to ensure that an actual size of the compressed video bitstream. BS generated from encoding the video sequence VS_IN is not larger than the target maximum compressed bitstream size cuBSr₀.

In another exemplary design, the control circuit 108 may adaptively adjust the encoding behavior of the video encoder 102 at one time stamp according to the transmission status of the communication link 106 (which is indicated by the information INF1), and may adaptively adjust the encoding behavior of the video encoder 102 at another time stamp according to the transmission status of the communication link 106 (which is indicated by the information INF1) and additional information (e.g., the encoding status of the video encoder 102 as indicated by the information INF2, or the buffer status of the stream buffer 104 as indicated by the information INF3). For example, the control circuit 108 controls the encoding behavior of the video encoder 102 by setting at least one encoding parameter of the video encoder 102, wherein the video sequence VS_IN includes a plurality of video frames to be encoded by the video encoder 102, and the at least one encoding parameter of the video encoder 102 includes a target maximum compressed bitstream size (i.e., a target bit budget) of a portion of the video sequence VS_IN that is not encoded by the video encoder 102 yet. In addition, a time-variant link capacity (e.g., network bandwidth) is possessed by the communication link 101.

Before the video encoding operation is applied to the video sequence VS_IN (which includes more than one video frame), the information INF1 obtained by the control circuit 108 at a time stamp t₀ may indicate that the transmitter 106 is configured to have a link capacity (e.g., network bandwidth) X₀ within a time slot TS_{t0,t1} from the current time stamp t₀ to a next time stamp t₁. At the time tamp t₀, the control circuit 108 refers to the link capacity (e.g., network bandwidth) X₀ within the time slot TS_{t0,t1} to initially estimate a target maximum compressed bitstream size cuBSr₀ of a first portion of the video sequence VS_IN (i.e., a target bit budget of a compressed stream generated from encoding a first portion of the video sequence VS_IN), and transmits the target maximum compressed bitstream size cuBSr₀ to the video encoder 102 via the control signal S_{ctrl}. The first portion of the video sequence VS_IN may be a complete video frame of the video sequence VS_IN or a partial video frame (e.g., a slice in one video frame or some CUs in one video frame) of the video sequence. After notified by the control signal S_{ctrl}, a rate controller (not shown) in the video encoder 102 may refer to the target maximum compressed bitstream size cuBSr₀ decided by the control circuit 108 to adaptively adjust a quantization parameter (QP) of each coding unit included in the first portion of the video sequence VS_IN to ensure that an actual size of a compressed bitstream generated from encoding the first portion of the video sequence VS_IN is not larger than the target maximum compressed bitstream size cuBSr₀.

At the time stamp t₁, the information INF1 obtained by the control circuit 108 may indicate that the transmitter 106 is configured to have the link capacity (e.g., network bandwidth) changed from X₀ to X₁ within a time slot TS_{t1,t2} from the current time stamp t₁ to a next time stamp t₂. At the time stamp t₁, the information INF3 may indicate that the non-transmitted bitstream size (i.e., a size of encoded video data that are kept in the stream buffer 104 and are still waiting for being transmitted via the communication link 101) is ts₀. Hence, at the time stamp t₁, the control circuit 108 refers to the transmission status of the communication link 101 (e.g., X₀ and/or X₁) and the buffer status of the stream buffer 104 (e.g., ts₀) to estimate a target maximum compressed bitstream size cuBSr₁ of a second portion of the video sequence VS_IN (i.e., a target bit budget of a compressed stream generated from encoding a second portion of the video sequence VS_IN), and transmits the target maximum compressed bitstream size cuBSr₁ to the video encoder 102 via the control signal S_{ctrl}. The second portion of the video sequence VS_IN may be a complete video frame of the video sequence VS_IN or a partial video frame (e.g., a slice in one video frame or some CUs in one video frame) of the video sequence VS_IN.

For example, the target maximum compressed bitstream size cuBSr₁ can be derived according to X₁ minus ts₀ (i.e., cuBSr₁=X₁−ts₀). For another example, a link capacity (e.g., network bandwidth) at a next time stamp t₂ can be predicted using X₀ and X₁, and the predicted link capacity (e.g., network bandwidth) at the next time stamp t₂ can be used in estimating the target maximum compressed bitstream size cuBSr₁. Assuming that a linear prediction model of the link capacity variation (e.g., network bandwidth variation) of the communication link 101 is used, the predicted link capacity (e.g., network bandwidth) at the next time stamp t₂ can be simply derived from X₁+(X₁−X₀). Hence, the target maximum compressed bitstream size cuBSr₁ can be derived according the predicted link capacity (e.g., network bandwidth) X₁+(X₁−X₀) minus ts₀ (i.e., cuBSr₁=X₁+(X₁−X₀)−ts₀). Alternatively, a non-linear prediction model of the link capacity variation (e.g., network bandwidth variation) of the communication link 101 may be used to predict the link capacity (e.g., network bandwidth) at the next time stamp t₂.

After notified by the control signal S_{ctrl}, a rate controller (not shown) in the video encoder 102 may refer to the target maximum compressed bitstream size cuBSr₁ decided by the control circuit 108 to adaptively adjust a quantization parameter (QP) of each coding unit included in the second portion of the video sequence VS_IN to ensure that an actual size of a compressed bitstream generated from encoding the second portion of the video sequence VS_IN is not larger than the target maximum compressed bitstream size cuBSr₁.

In above example, the control circuit 108 obtains the buffer status of the stream buffer 104 by actively monitoring the stream buffer 104 to get the information INF3 or passively informed of the information INF3 provided from the stream buffer 104. Alternatively, the information INF3 may be omitted, and the control circuit 108 may be modified to predict the buffer status of the stream buffer 104 without actively monitoring the stream buffer 104 to get the information INF3 or passively informed of the information INF3 provided from the stream buffer 104. The same objective of adaptively controlling the encoding behavior of the video encoder 102 in response to the bandwidth variation of the communication link 101 is achieved.

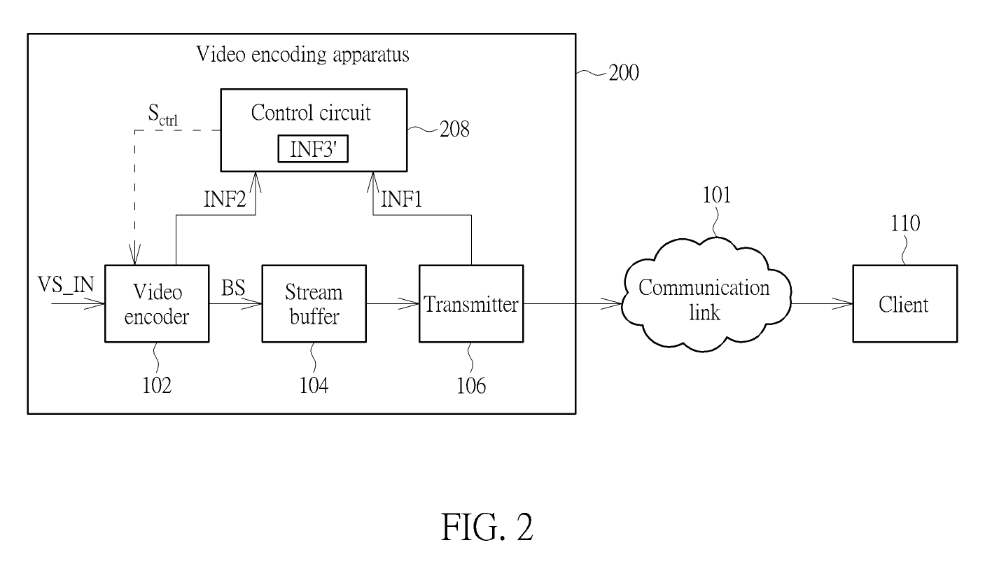

FIG. 2 is a diagram illustrating a second video encoding apparatus according to an embodiment of the present invention. The major difference between the video encoding apparatuses 100 and 200 is that the control circuit 208 obtains predicted information INF3′ according to the information INF1 and the information INF2, wherein the predicted information INF3′ is indicative of the predicted buffer status of the stream buffer 104. Like the control circuit 108 shown in FIG. 1, the control circuit 208 may act as a bitrate management unit for applying real-time adaptive bitrate management/adjustment to the video encoder 102.

Before the video encoding operation is applied to the video sequence VS_IN (which includes more than one video frame), the information INF1 obtained by the control circuit 208 at a time stamp t₀ may indicate that the transmitter 106 is configured to have a link capacity (e.g., network bandwidth) X₀ within a time slot TS_{t0,t1} from the current time stamp t₀ to a next time stamp t₁. At the time tamp t₀, the control circuit 208 refers to the link capacity (e.g., network bandwidth) X₀ within the time slot TS_{t0,t1} to initially estimate a target maximum compressed bitstream size cuBSr₀ of a first portion of the video sequence VS_IN (i.e., a target bit budget of a compressed stream generated from encoding a first portion of the video sequence VS_IN), and transmits the target maximum compressed bitstream size cuBSr₀ to the video encoder 102 via the control signal S_{ctrl}. The first portion of the video sequence VS_IN may be a complete video frame of the video sequence VS_IN or a partial video frame (e.g., a slice in one video frame or some CUs in one video frame) of the video sequence VS_IN. After notified by the control signal S_{ctrl}, a rate controller (not shown) in the video encoder 102 may refer to the target maximum compressed bitstream size cuBSr₀ decided by the control circuit 208 to adaptively adjust a quantization parameter (QP) of each coding unit included in the first portion of the video sequence VS_IN to ensure that an actual size of a compressed bitstream generated from encoding the first portion of the video sequence VS_IN is not larger than the target maximum compressed bitstream size cuBSr₀.

At the time stamp t₁, the information INF1 obtained by the control circuit 208 may indicate that the transmitter 106 is configured to have the link capacity (e.g., network bandwidth) changed from X₀ to X₁ within a time slot TS_{t1,t2} from the current time stamp t₁ to a next time stamp t₂. At the time stamp t₁, the information INF2 obtained by the control circuit 208 indicates an actual size S₀ of a compressed bitstream that is generated from encoding data of the first portion of the video sequence VS_IN within the time slot TS_{t0,t1}, and the predicted information INF3′ obtained by the control circuit 208 indicates a predicted non-transmitted bitstream size (i.e., a predicted size of encoded video data that are kept in the stream buffer 104 and are still waiting for being transmitted via the communication link 101) cuBSenc₀. For example, the predicted non-transmitted bitstream size cuBSenc₀ may be derived from X₀ minus S₀ (i.e., cuBSenc₀=X₀−S₀). Hence, at the time stamp t₁, the control circuit 208 refers to the transmission status of the communication link 101 (e.g., X₀ and/or X₁) and the predicted buffer status of the stream buffer 104 (e.g., cuBSenc₀) to estimate a target maximum compressed bitstream size cuBSr₁ of a second portion of the video sequence VS_IN (i.e., a target bit budget of a compressed stream generated from encoding a second portion of the video sequence VS_IN), and transmits the target maximum compressed bitstream size cuBSr₁ to the video encoder 102 via the control signal S_{ctrl}. The second portion of the video sequence VS_IN may be a complete video frame of the video sequence VS_IN or a partial video frame (e.g., a slice in one video frame or some CUs in one video frame) of the video sequence VS_IN.

For example, the target maximum compressed bitstream size cuBSr₁ can be derived according to X₁ minus cuBSenc₀ (i.e., cuBSr₁=X₁−cuBSenc₀). For another example, a link capacity (e.g., network bandwidth) at a next time stamp t₂ can be predicted using X₀ and X₁, and the predicted link capacity (e.g., network bandwidth) at the next time stamp t₂ can be used in estimating the target maximum compressed bitstream size cuBSr₁. Assuming that a linear prediction model of the link capacity variation (e.g., network bandwidth variation) of the communication link 101 is used, the predicted link capacity (e.g., network bandwidth) at the next time stamp t₂ can be simply derived from X₁+(X₁−X₀). Hence, the target maximum compressed bitstream size cuBSr₁ can be derived according the predicted link capacity (e.g., network bandwidth) X₁+(X₁−X₀) minus cuBSenc₀ (i.e., cuBSr₁=X₁+(X₁−X₀)−cuBSenc₀). Alternatively, a non-linear prediction model of the link capacity variation (e.g., network bandwidth variation) of the communication link 101 may be used to predict the link capacity (e.g., network bandwidth) at the next time stamp t₂.

After notified by the control signal S_{ctrl}, a rate controller (not shown) in the video encoder 102 may refer to the target maximum compressed bitstream size cuBSr₁ decided by the control circuit 208 to adaptively adjust a quantization parameter (QP) of each coding unit included in the second portion of the video sequence VS_IN to ensure that an actual size of a compressed bitstream generated from encoding the second portion of the video sequence VS_IN is not larger than the target maximum compressed bitstream size cuBSr₁.

It should be noted that the video encoding apparatus 100 shown in FIG. 1 may be configured to support two buffer status acquisition modes, one for obtaining the actual buffer status of the stream buffer 104 (as illustrated in FIG. 1), and the other for obtaining the predicted buffer status of the stream buffer 104 (as illustrated in FIG. 2). This also falls within the scope of the present invention.

Since the video encoding apparatus 100/200 is capable of applying adaptive rate control to the video encoder 102 according to the transmission status of the local transmitter 106 instead of a data reception feedback given from the remote client 110, the response of the adaptive rate control is quick, and the latency of the communication link 101 is short. Hence, the video encoding apparatus 100/200 with real-time adaptive bit rate management is applicable to low-latency network applications (e.g., low-latency WiFi applications) with bandwidth variation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video encoding apparatus comprises:
a video encoder, arranged to encode a video sequence into a compressed video bitstream;
a transmitter, arranged to transmit the compressed video bitstream via a communication link; and
a control circuit, arranged to adaptively adjust an encoding behavior of the video encoder according to at least a transmission status of the communication link.

2. The video encoding apparatus of claim 1, wherein the control circuit is further arranged to obtain the transmission status of the communication link from a transmission setting of the transmitter.

3. The video encoding apparatus of claim 1, wherein the control circuit controls the encoding behavior of the video encoder by setting at least one encoding parameter of the video encoder, and the at least one encoding parameter of the video encoder comprises a target maximum compressed bitstream size of at least a portion of the video sequence that is not encoded by the video encoder yet.

4. The video encoding apparatus of claim 3, wherein the video sequence comprises a plurality of video frames; and said at least a portion of the video sequence is the video sequence, or a complete video frame of the video sequence, or a partial video frame of the video sequence.

5. The video encoding apparatus of claim 1, further comprising:
a stream buffer, arranged to receive data of the compressed video bitstream from the video encoder, and provide buffered data of the compressed video bitstream to the transmitter;
wherein the control circuit adaptively adjusts the encoding behavior of the video encoder according to the transmission status of the communication link and a buffer status of the stream buffer.

6. The video encoding apparatus of claim 5, wherein the control circuit controls the encoding behavior of the video encoder by setting at least one encoding parameter of the video encoder; and the at least one encoding parameter of the video encoder comprises a target maximum compressed bitstream size of a portion of the video sequence that is not encoded by the video encoder yet.

7. The video encoding apparatus of claim 1, wherein the control circuit adaptively adjusts the encoding behavior of the video encoder according to the transmission status of the communication link and an encoding status of the video encoder.

8. The video encoding apparatus of claim 7, further comprising:
a stream buffer, arranged to receive data of the compressed video bitstream from the video encoder, and provide buffered data of the compressed video bitstream to the transmitter;
wherein the control circuit is further arranged to predict a buffer status of the stream buffer according to the transmission status of the communication link and the encoding status of the video encoder, and the encoding behavior of the video encoder is adaptively adjusted according to the transmission status of the communication link and the predicted buffer status of the stream buffer.

9. The video encoding apparatus of claim 7, wherein the encoding status of the video encoder comprises a size of a portion of the compressed video bitstream generated by the video encoder; the video sequence comprises a plurality of video frames; and the portion of the compressed video bitstream is a compressed bitstream of a complete video frame of the video sequence or a compressed bitstream of a partial video frame of the video sequence.

10. The video encoding apparatus of claim 7, wherein the control circuit controls the encoding behavior of the video encoder by setting at least one encoding parameter of the video encoder; and the at least one encoding parameter of the video encoder comprises a target maximum compressed bitstream size of a portion of the video sequence that is not encoded by the video encoder yet.

11. A video encoding method comprises:
adaptively adjusting an encoding behavior of a video encoding operation according to at least a transmission status of a communication link;
performing the video encoding operation to encode a video sequence into a compressed video bitstream; and
transmitting the compressed video bitstream via the communication link.

12. The video encoding method of claim 11, wherein the compressed video bitstream is transmitted by a transmitter, and the video encoding method further comprises:
obtaining the transmission status of the communication link from a transmission setting of the transmitter.

13. The video encoding method of claim 11, wherein the encoding behavior of the video encoding operation is controlled by setting at least one encoding parameter of the video encoding operation, and the at least one encoding parameter of the video encoding operation comprises a target maximum compressed bitstream size of at least a portion of the video sequence that is not encoded yet.

14. The video encoding method of claim 13, wherein the video sequence comprises a plurality of video frames; and said at least a portion of the video sequence is the video sequence, or a complete video frame of the video sequence, or a partial video frame of the video sequence.

15. The video encoding method of claim 11, further comprising:
storing data of the compressed video bitstream into a stream buffer; and
reading buffered data of the compressed video bitstream from the stream buffer for transmission;
wherein the encoding behavior of the video encoding operation is adaptively adjusted according to the transmission status of the communication link and a buffer status of the stream buffer.

16. The video encoding method of claim 15, wherein the encoding behavior of the video encoding operation is controlled by setting at least one encoding parameter of the video encoding operation; and the at least one encoding parameter of the video encoding operation comprises a target maximum compressed bitstream size of a portion of the video sequence that is not encoded by the video encoding operation yet.

17. The video encoding method of claim 11, wherein the encoding behavior of the video encoding operation is adaptively adjusted according to the transmission status of the communication link and an encoding status of the video encoding operation.

18. The video encoding method of claim 17, further comprising: storing data of the compressed video bitstream into a stream buffer;
reading buffered data of the compressed video bitstream from the stream buffer for transmission; and
predicting a buffer status of the stream buffer according to the transmission status of the communication link and the encoding status of the video encoding operation;
wherein the encoding behavior of the video encoding operation is adaptively adjusted according to the transmission status of the communication link and the predicted buffer status of the stream buffer.

19. The video encoding method of claim 17, wherein the encoding status of the video encoding operation comprises a size of a portion of the compressed video bitstream generated by the video encoding operation; the video sequence comprises a plurality of video frames; and the portion of the compressed video bitstream is a compressed bitstream of a complete video frame of the video sequence or a compressed bitstream of a partial video frame of the video sequence.

20. The video encoding method of claim 17, wherein the encoding behavior of the video encoding operation is controlled by setting at least one encoding parameter of the video encoding operation, and the at least one encoding parameter of the video encoding operation comprises a target maximum compressed bitstream size of a portion of the video sequence that is not encoded by the video encoding operation yet.
